(19) United States
(12) Patent Application Publication
(10) Pub. No.: US 2004/0040347 A1
(43) Pub. Date: Mar. 4, 2004

(54) Tamper resistant lock

(76) Inventor: Robert A. Vito, Berwyn, PA (US)

Correspondence Address: VOLPE AND KOENIG, P.C., UNITED PLAZA, SUITE 1600, 30 SOUTH 17TH STREET, PHILADELPHIA, PA, 19103, US

(21) Appl. No.: 10/269,831

(22) Filed: Oct. 11, 2002

Related U.S. Application Data
(63) Continuation-in-part of application No. 29/166,592, filed on Aug. 30, 2002.
(63) Continuation-in-part of application No. 10/253,452, filed on Sep. 24, 2002.

(51) Int. Cl. E05B 73/00

(52) U.S. Cl. 70/18

(57) ABSTRACT

A lock including a lock body having a first side. The lock body defines a first area having a first opening to the first side of the lock body. The lock body defines a second area having a second opening through the first side of the lock body. The first and second openings result in the lock body having a first outer leg, a central leg, and second outer leg. The first outer leg and the central leg border the first opening. The second outer leg and the central leg border the second opening. At least one rod is detachably slidably engageable with the lock body to close the first and second openings and is adapted to be located in the first outer leg, the central leg, and at least a portion of the second outer leg to form first and second closed areas.

### CROSS REFERENCE TO RELATED APPLICATION

This application is a continuation-in-part and claims priority from: U.S. Design patent application Ser. No. 29/166,592, filed Aug. 30, 2002, and entitled “Cycle Lock”; and U.S. patent application Ser. No. 10/253,452, filed Sep. 24, 2002, and entitled “Adjustable Folding Lock”; which are both hereby incorporated by reference herein in their entirety as if fully set forth.

### BACKGROUND

The present application is directed to locks in general and, more specifically, to a sturdy, tamper resistant lock.

In the past, people concerned with locking their possessions to a fixed object typically used a chain or cable that was interwoven around the possession and the fixed object, such as a lamppost. While the use of chains, cables, or other flexible locking mechanisms provided a positive locking device that can be compactly stored, such devices are relatively simple to disable using bolts cutters or the like.

Clearly, what is needed is heavy duty lock that is of sturdy manufacture, that is tamper resistant, and that is easy to use.

### SUMMARY

One embodiment of the present invention is directed to a lock including a first arcuate member defining a first opening. A second arcuate member is located on the first arcuate member and defines a second opening oriented in the same direction as the first opening. The first and second arcuate members combine to form a first outer leg, a central leg, and a second outer leg. The first outer leg and the central leg border the first opening. The second outer leg and the central leg 0border the second opening. At least one rod is detachably slidably engageable with the first and second arcuate members and is adapted to be positioned in the first outer leg, the central leg and at least a portion of the second outer leg to close the first and second openings to form first and second closed areas. A locking mechanism detachably secures the at least one rod to the at least one of the first and second arcuate members.

Another embodiment of the present invention is directed to a lock including a lock body having a first side. The lock body defines a first area having a first opening to the first side of the lock body. The lock body defines a second area having a second opening to the first side of the lock body. The first and second openings result in the lock body having a first outer leg, a central leg, and a second outer leg. The first outer leg and the central leg border the first opening. The second outer leg and the central leg border the second opening. At least one rod is detachably slidably engageable with the lock body to close the first and second openings and is adapted to be located in the first outer leg, the central leg, and at least a portion of the second outer leg to form first and second closed areas. A locking mechanism detachably secures the at least one rod to the lock body.

### BRIEF DESCRIPTION OF THE DRAWINGS

The foregoing summary, as well as the following detailed description of the preferred embodiments of the invention, will be better understood when read in conjunction with the appended drawings. For the purpose of illustrating the invention, there are shown in the drawings embodiments which are presently preferred. It is understood, however, that the invention is not limited to the precise arrangements and instrumentalities shown. In the drawings:

FIG. 1 is a perspective view of a first preferred embodiment of a lock according to the present invention;

FIG. 2 is a left side elevational view of the lock of FIG. 1;

FIG. 3 is a right side elevational view of the lock of FIG. 1;

FIG. 4 is a top plan view of the lock of FIG. 1 illustrating a polymer grip placed thereon;

FIG. 5 is a perspective view of the lock of FIG. 1 illustrating a rod partially engaged with the lock;

FIG. 6 is a perspective view of the lock of FIG. 1 securing a bicycle frame to a sign post;

FIG. 7 is a perspective partial view of the lock of FIG. 1 securing a bicycle wheel to a bicycle frame;

FIG. 8 is a partial cross-sectional view of the lock of FIG. 1 as taken along the line 8-8 of FIG. 1 illustrating the securing of the rod therein;

FIG. 9 is a cross-sectional view of the lock of FIG. 1 as taken along the line 9-9 of FIG. 1;

FIG. 10 is a partial cross-sectional view similar to that of FIG. 9 illustrating the right portion of FIG. 9 when the lock of FIG. 1 is formed, in part, using rectangular tubing;

FIG. 11 is a partial cross-sectional view of the lock illustrating an end of the rod that is flush with an outer surface of the lock;

FIG. 12 is a partial cross-sectional view similar to that of FIG. 11 illustrating the rod with a dome shaped head;

FIG. 13 is a partial cross-sectional view similar to that of FIG. 11 illustrating the rod having a head that is positioned within a recessed shoulder in the lock;

FIG. 14 is a partial cross-sectional view similar to that of FIG. 11 illustrating the rod with a beveled head that is partially recessed within the lock;

FIG. 15 illustrates a cross-sectional view similar to that of FIG. 8 illustrating the securing of the rod within the lock and a rod engaging mechanism which prevents the rod from being completely withdrawn from the lock;

FIG. 16 is a partial cross-sectional view of the left portion of FIG. 15 illustrating the engagement of the rod with the rod engaging mechanism;

FIG. 17 is a cross-sectional view similar to that of FIG. 15 illustrating a second preferred rod engaging mechanism;

FIG. 18 is a cross-sectional view of a left portion of FIG. 17;

FIG. 19 is a cross-sectional view of the lock of FIG. 18 as taken along the line 19-19 of FIG. 18;

FIG. 20 is a cross-sectional view similar to that of FIG. 17 illustrating a third preferred embodiment of the rod engaging mechanism;

FIG. 21 is a cross-sectional view of the left portion of FIG. 20 illustrating the engagement between the rod engaging mechanism and the rod;

FIG. 22 is a partial cross-sectional view similar to that of FIG. 20 illustrating a fourth preferred rod engaging mechanism for preventing the rod from being completely withdrawn from the lock without a applying an increased amount of force thereon;

FIG. 23 is a cross-sectional view of the left portion of FIG. 22 illustrating the engagement between the rod engaging mechanism and the rod;

FIG. 24 is a cross-sectional view of the lock of FIG. 23 as taken along the line 24-24 of FIG. 23;

FIG. 25 is a perspective view of a lock according to a second preferred embodiment of the present invention;

FIG. 26 is a right side elevational view of the lock of FIG. 25;

FIG. 27 is a cross-sectional view of the lock of FIG. 25 as taken along the line 27-27 of FIG. 25;

FIG. 28 is a top plan view of the lock of FIG. 25;

FIG. 29 is a perspective view of a lock according to a third preferred embodiment of the present invention that secures first and second pins in a central portion thereof;

FIG. 30 is a perspective view of the lock of FIG. 29 with the first and second pins partially inserted therein;

FIG. 31 is a partial cross-sectional view of the lock of FIG. 29 as taken along the line 31-31 of FIG. 29;

FIG. 32 is a cross-sectional view of the lock of FIG. 31 as taken along the line 32-32 of FIG. 31;

FIG. 33 is a perspective view of a lock according to a fourth preferred embodiment of the present invention illustrating a lock that can fold onto itself;

FIG. 34 is a second perspective view of the lock of FIG. 33 with the lock folded over onto itself;

FIG. 35 is a front elevational view of the lock of FIG. 33;

FIG. 36 is a front elevational view of the lock of FIG. 34;

FIG. 37 is a perspective view of a lock according to a fifth preferred embodiment of the present invention that is also capable of folding onto itself;

FIG. 38 is a front elevational view of the lock of FIG. 37 in a first extended position;

FIG. 39 is a front elevational view of the lock of FIG. 37 in a second folded position;

FIG. 40 is a perspective view of a lock according to a sixth preferred embodiment of the present invention which capable of folding onto itself;

FIG. 41 is a front elevational view of the lock of FIG. 40 in a first preferred extended position;

FIG. 42 is a perspective view of the lock of FIG. 40 in a second preferred folded over position;

FIG. 43 is a front elevational view of the lock of FIG. 42;

FIG. 44 is a perspective view of a lock according to a seventh preferred embodiment of the present invention which is capable of being folded onto itself;

FIG. 45 is a perspective view of the lock of FIG. 44 in a preferred, second, folded over position;

FIG. 46 is a cross-sectional view of the lock FIG. 44 as taken along the line 46-46 of FIG. 44;

FIG. 47 is a front elevational view of the lock of FIG. 45;

FIG. 48 is a perspective view of a lock according to an eighth preferred embodiment of the present invention that receives first and second pins in a central portion thereof and which is also foldable over onto itself;

FIG. 49 is a front elevational view of the lock of FIG. 48;

FIG. 50 is a perspective view of the lock of FIG. 48 in a preferred, second, folded over position;

FIG. 51 is a partial cross-sectional view of the lock of FIG. 48 as taken along the line 51-51 of FIG. 48;

FIG. 52 is a cross-sectional view of the lock of FIG. 49 as taken along the line 52-52 of FIG. 49.

### DETAILED DESCRIPTION OF THE PREFERRED EMBODIMENTS

Certain terminology is used in the following description for convenience only and is not limiting. The words “right,” “left,” “top,” and “bottom” designate directions in the drawings to which reference is made. The words “inwardly” and “outwardly” refer to directions toward and away from, respectively, the geometric center of the lock and designated part thereof. The terminology includes the words above specifically mentioned, derivatives thereof, and words of similar import. Additionally, the words “a” and “one” are defined as including one or more of the referenced item unless specifically stated otherwise.

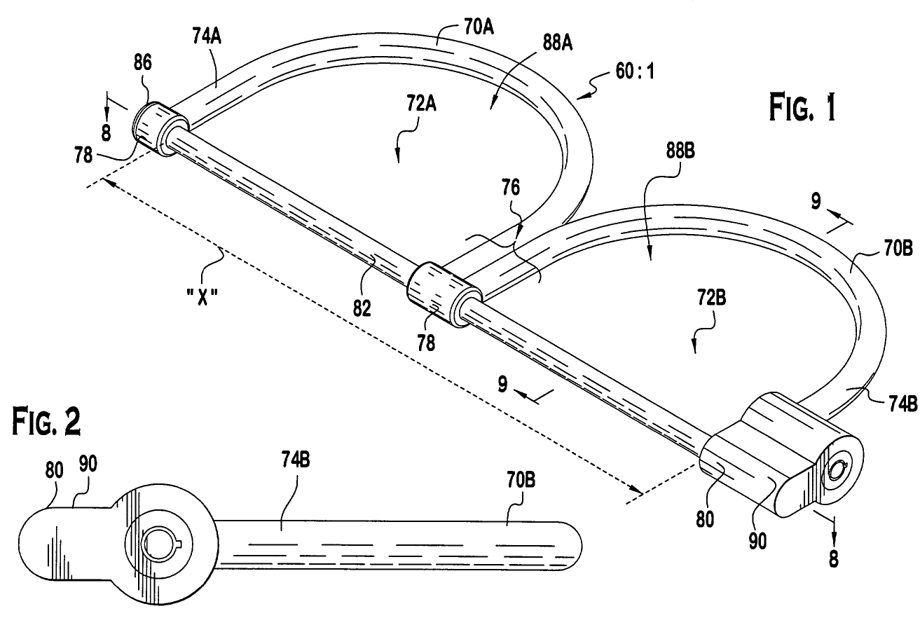

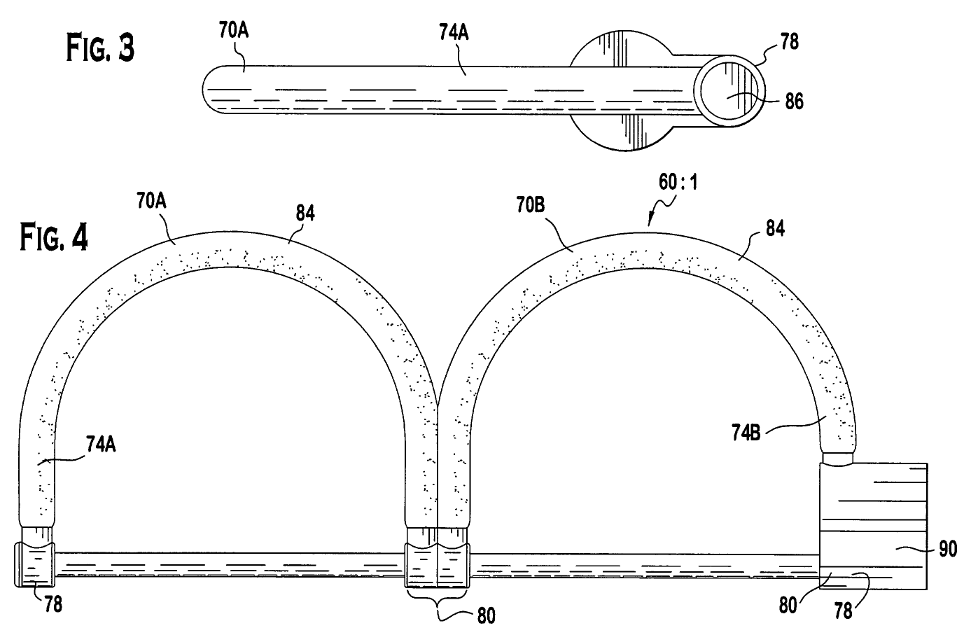

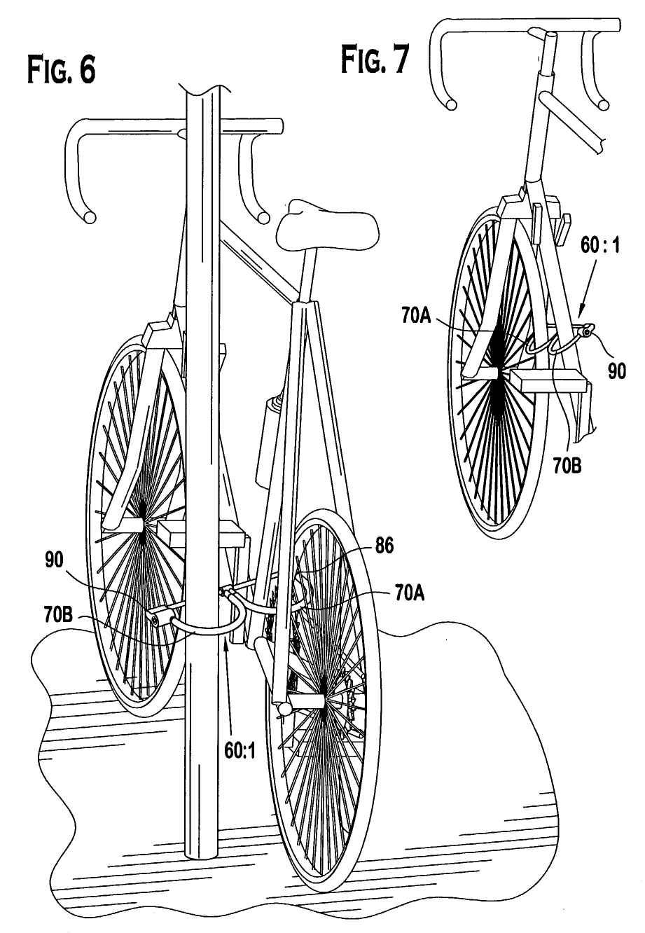

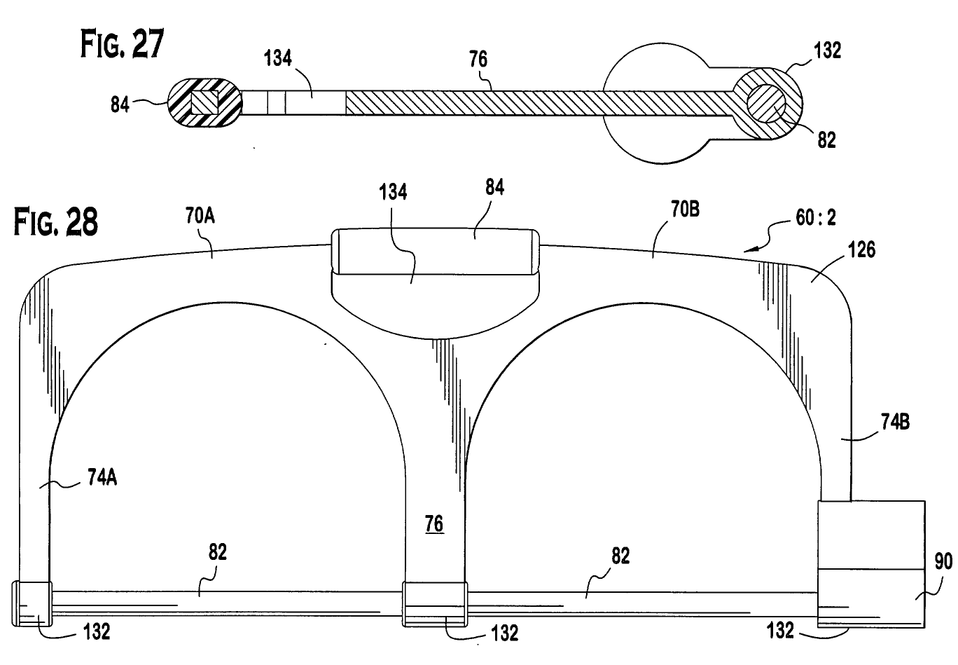

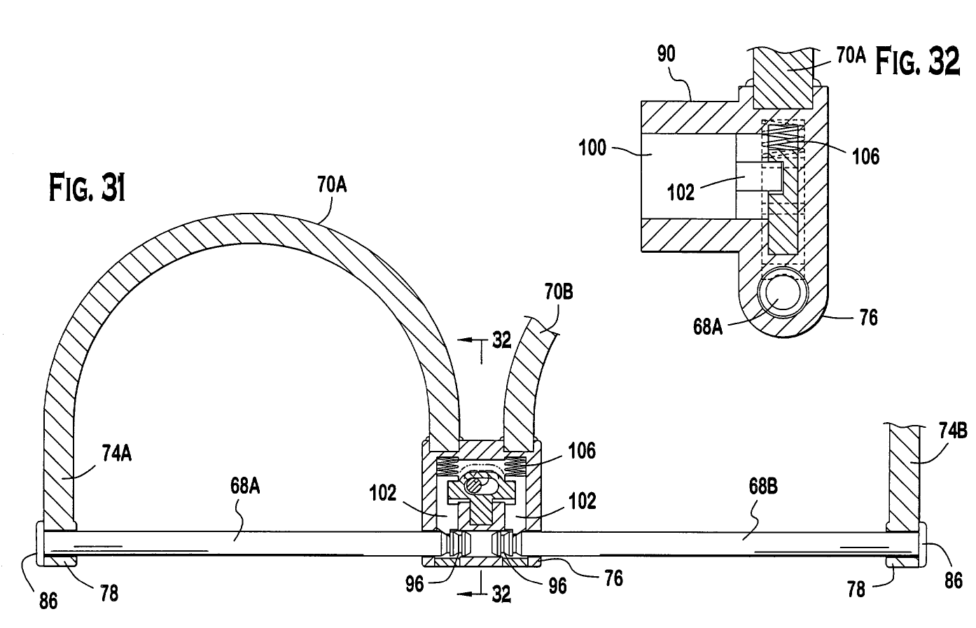

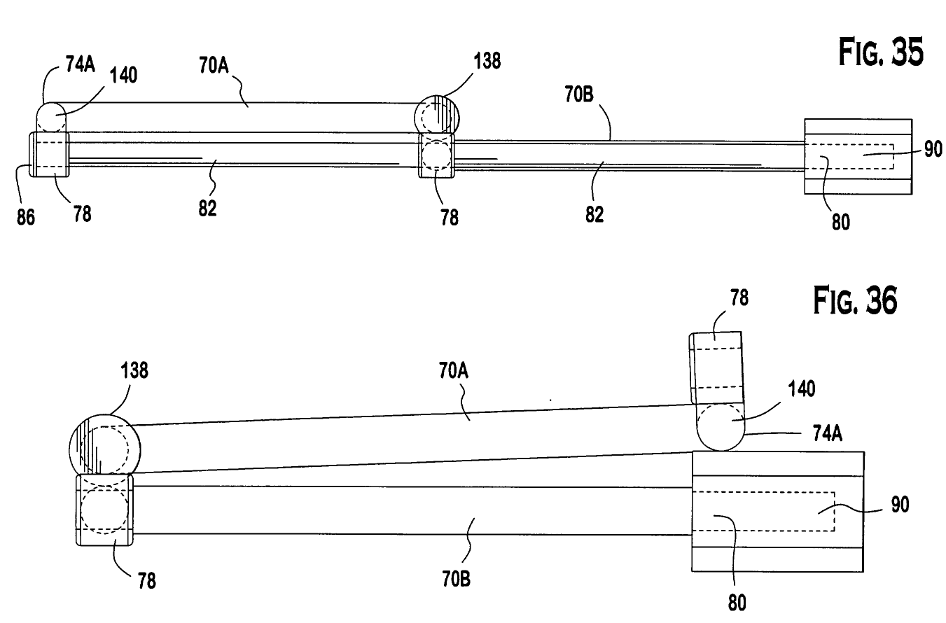

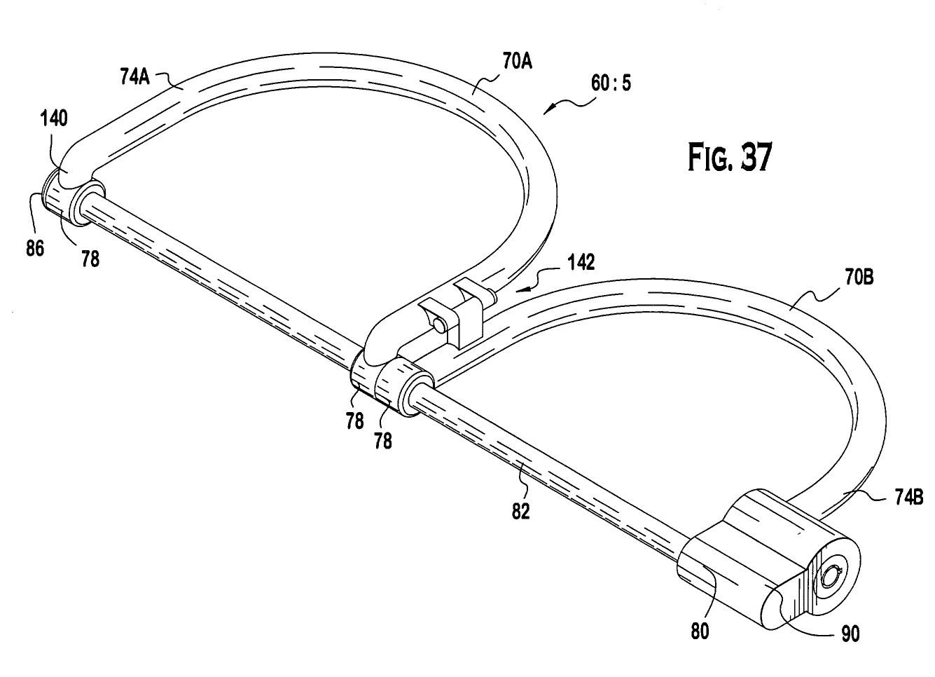

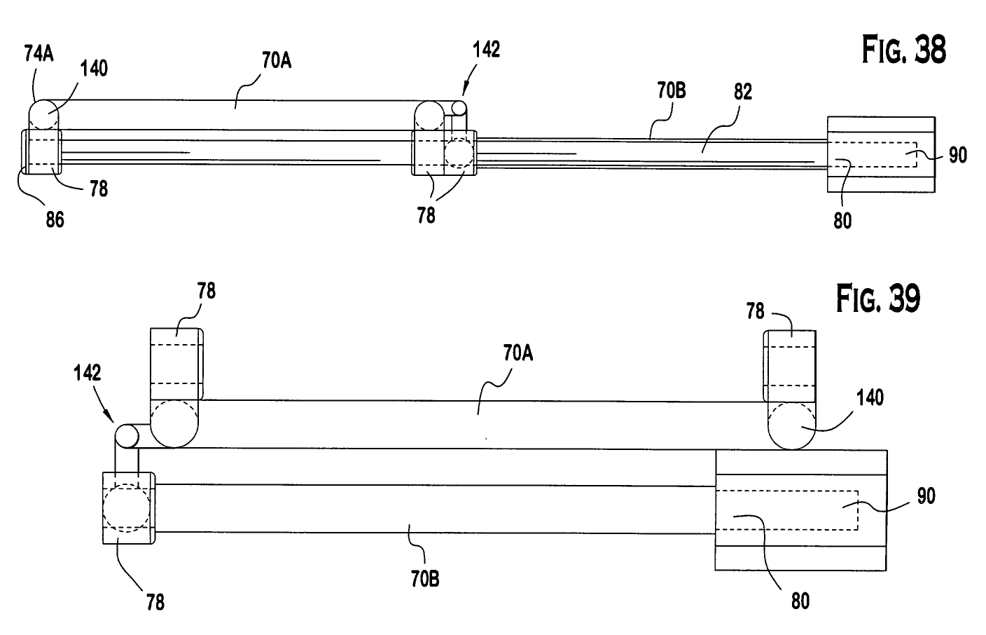

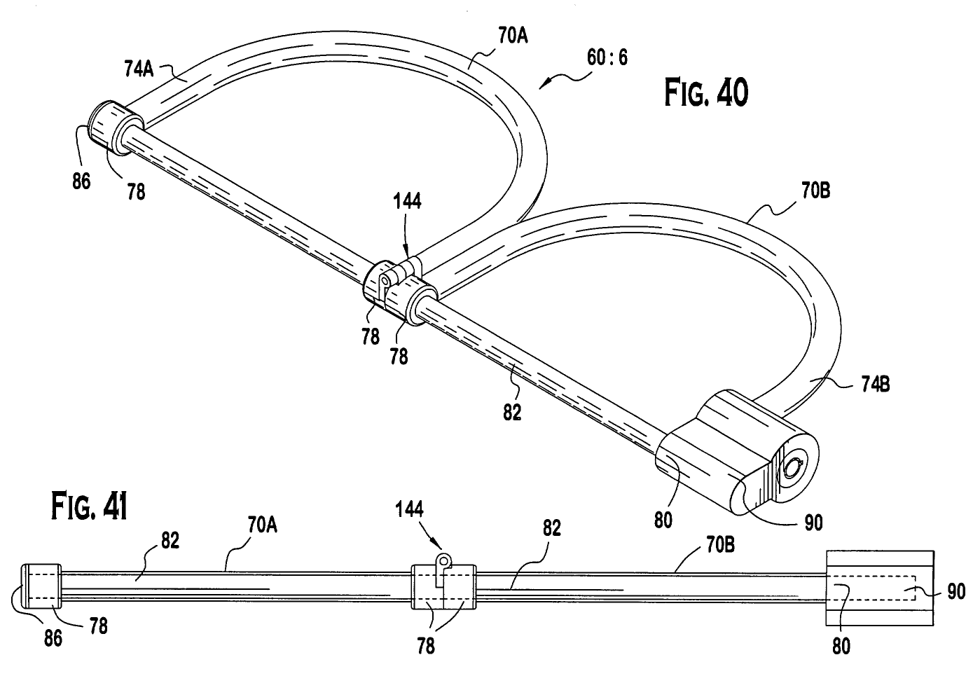

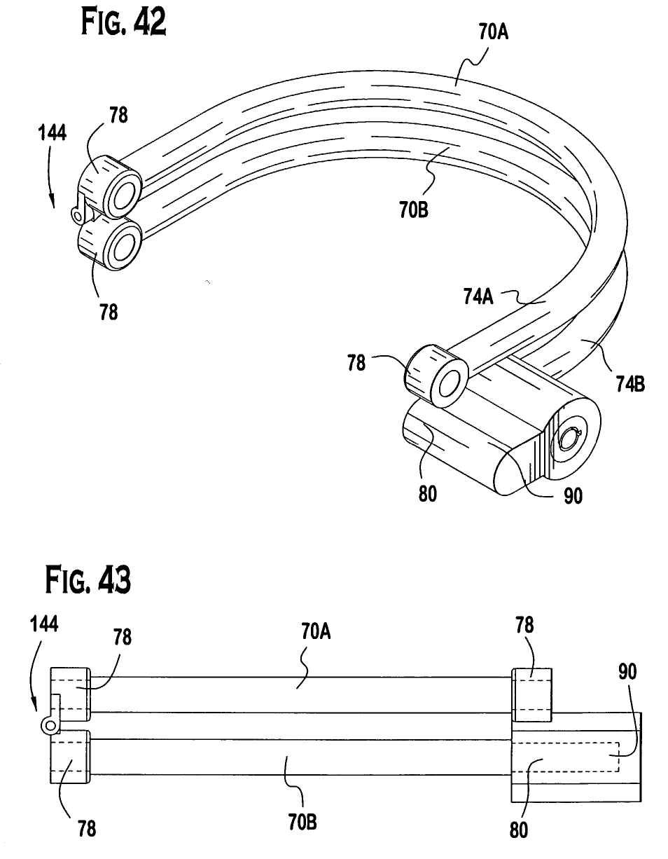

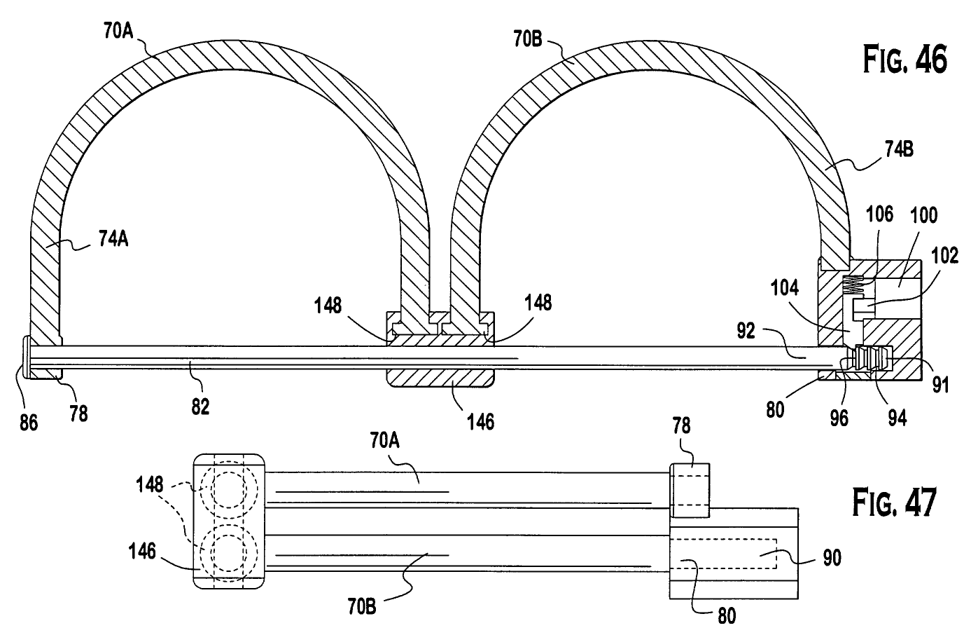

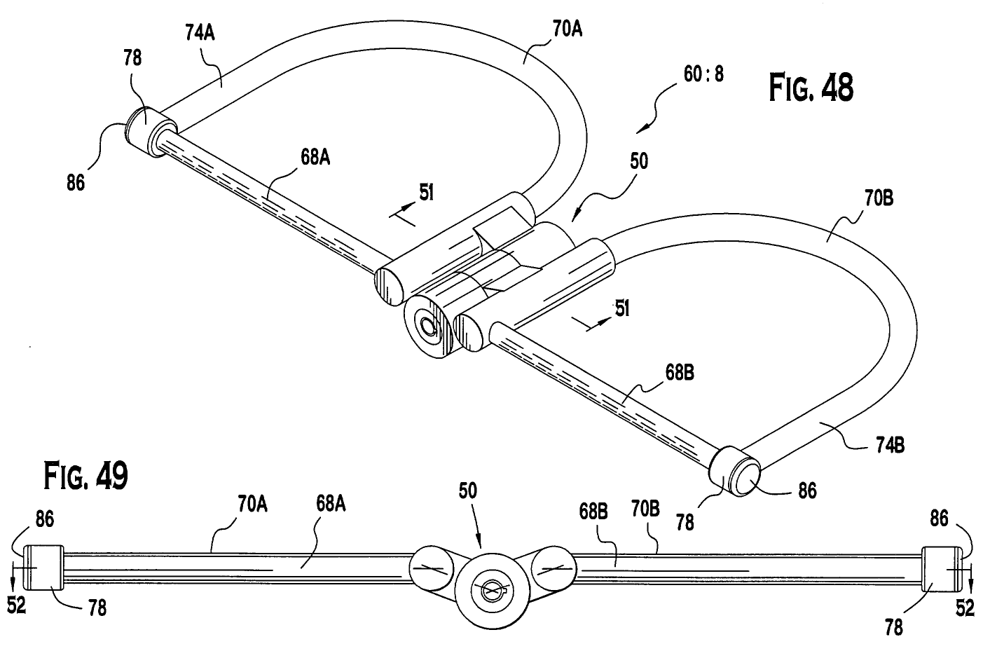

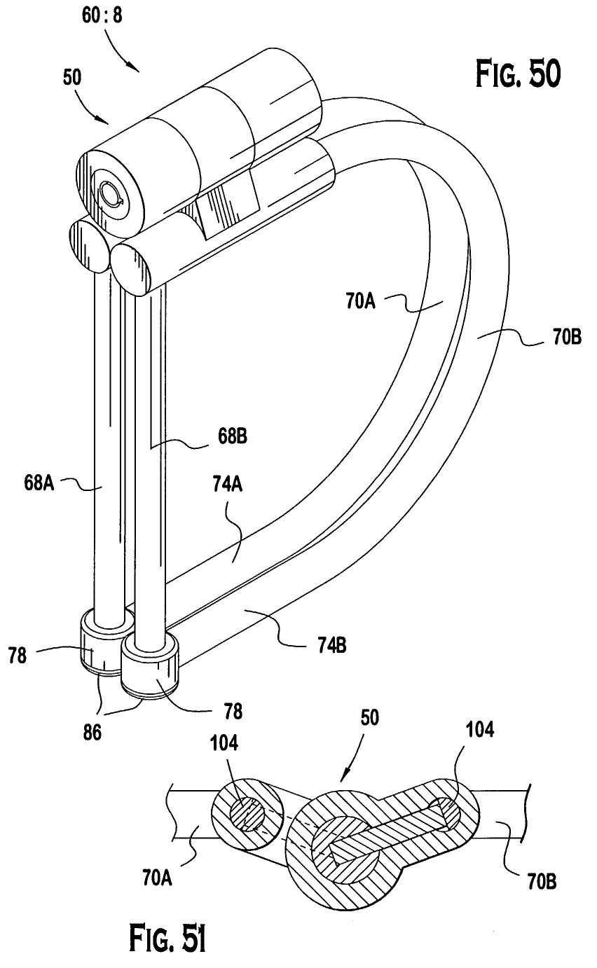

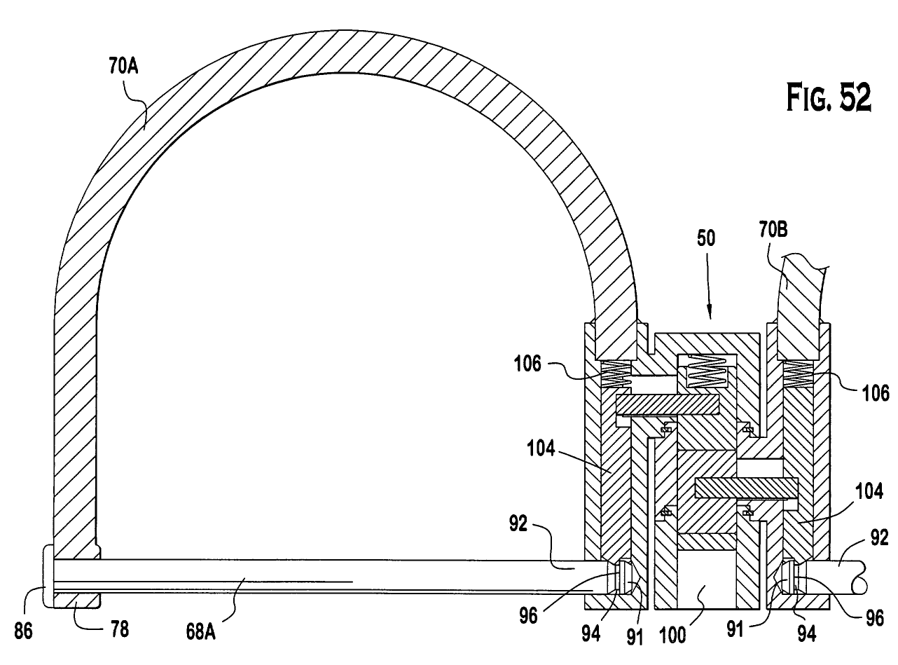

Referring to FIGS. 1-52 wherein like numerals indicate like elements throughout, there are shown eight preferred embodiments of a lock according to the present invention, generally designated 60:1-60:8. Briefly stated, locks 60:1-60:8 provide a sturdy, tamper resistant, and easy to use lock relative to prior known locks.

It is preferred that the lock 60:1-60:8 and its individual components are formed of a high strength, durable, impact resistant material, such as hardened steel. Those of ordinary skill in the art will appreciate from this disclosure that any suitable steels, alloys, suitable polymers, or the like can be used without departing from scope of the present invention. Preferably, an outer surface of the lock 60:1-60:8 is coated with a brightly colored paint or coating, such as a fluorescent colored paint or polymer coating, so that the lock 60:1-60:8 is prominently visible and noticeable when installed.

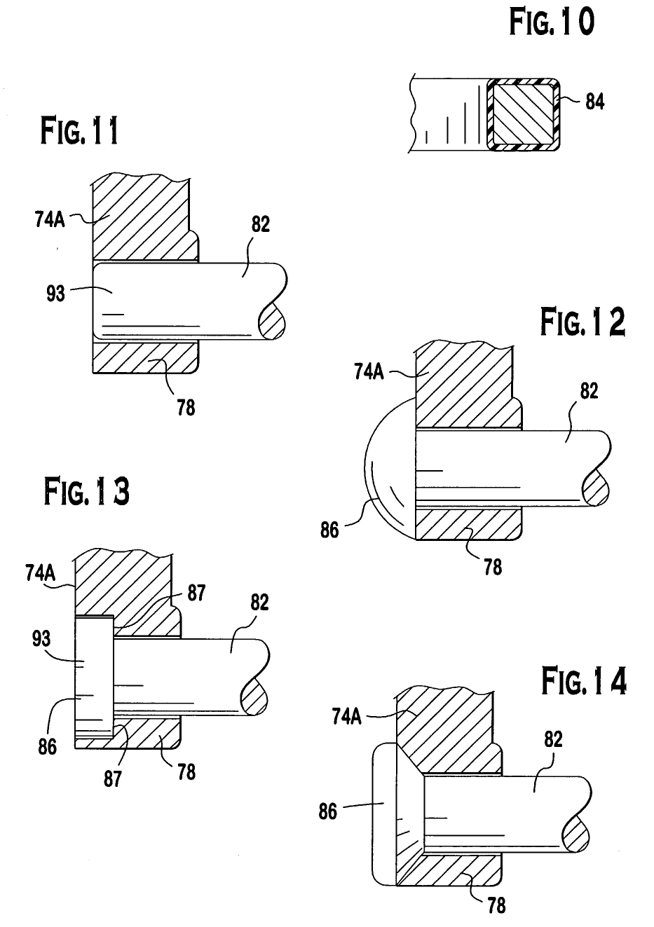

Referring to FIGS. 1-24, one embodiment of the lock 60:1 of the present invention includes a first arcuate member 70A defining a first opening 72A. It is preferred that the first and second arcuate members 70A, 70B (the second arcuate member is further described below) are formed of hardened steel and have generally circular cross-sections. However, those of ordinary skill in the art will appreciate from this disclosure that the cross-section of the arcuate members 70A, 70B can have any shape without departing from the scope of the present invention. For example, referring to FIG. 10, a portion of the second arcuate member 70B is shown as being formed by tubing having a generally square cross-section.

Referring again to FIG. 1, it is preferred, but not necessary, that the first and second arcuate members 70A, 70B have a generally U-shape. The shape of the first and second arcuate 70A, 70B results in the first and second openings (the second opening is further described below) preferably having a generally semi-elliptical shape.

The second arcuate member 70B is preferably located on the first arcuate member 70A and defines the second opening 72B which is oriented in the same direction as the first opening 72A. It is preferable that the first and second arcuate members 70A, 70B are welded together. However, those of ordinary skill in the art will appreciate from this disclosure that the first and second arcuate members 70A, 70B can be integrally formed without departing from the scope of the present invention.

The first and second arcuate members 70A, 70B combine to form a first outer leg 74A, a central leg 76, and a second outer leg 74B. Referring to FIGS. 4, 5, and 8, the central leg 76 preferably includes two legs that are joined together along a portion of the length of the two legs. The first outer leg 74A and the central leg 76 border the first opening 72A. The second outer leg 74B and the central leg 76 border the second opening 72B.

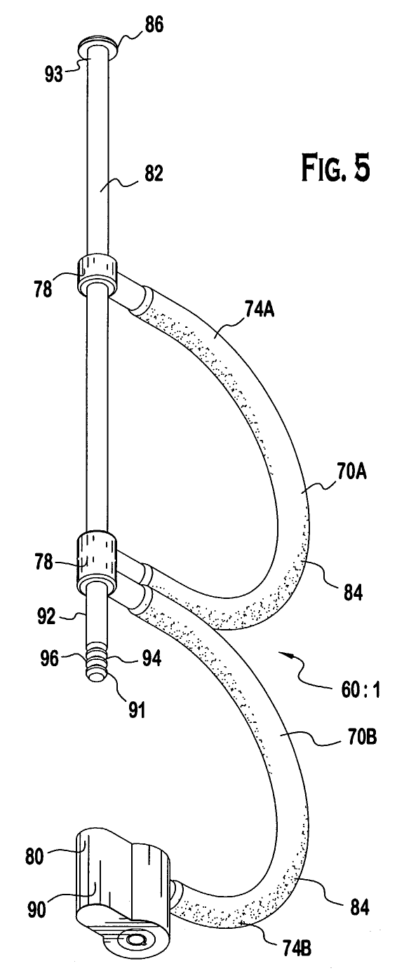

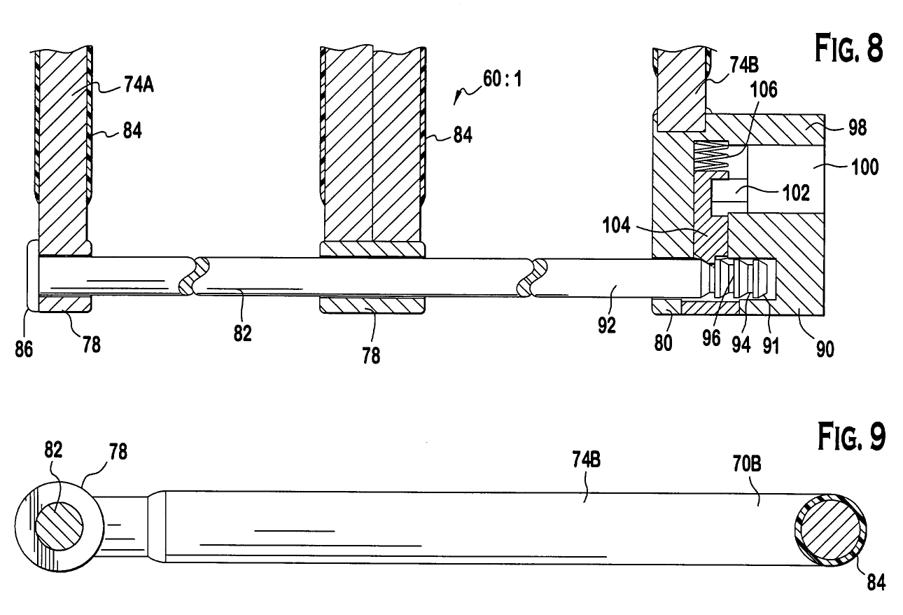

Referring to FIGS. 5 and 8 the first outer leg 74A and the central leg 76 each include a reinforcement tube 78 that is aligned to receive at least one rod 82 (further described below) therethrough. The second outer leg 74B has a second reinforcement tube 80 for receiving the rod 82 therein.

Referring to FIG. 1, it is preferred, but not necessary, that the distance “X” between an inner surface of the first outer leg 74A and an inner surface of the second outer leg 74B is between approximately twelve (12) inches and approximately seventeen (17) inches.

Referring to FIGS. 4, 5, 8, and 9, it is preferable that the first and second arcuate members 70A, 70B include a polymer grip 84. It is preferable, that the polymer grip 84 comprise a vinyl coating.

As best shown in FIG. 5, the at least one rod preferably has a generally cylindrical shape. The rod 82 may have a head 86. A detent 94 is preferably positioned on a lock engaging end of the rod 82. It is preferred that the detent 94 be a ratchet(s) 96. The rod is preferably detachably slidably engageable with the first and second arcuate members 70A, 70B and is adapted to positioned in the first outer leg 74A, the central leg 76, and at least a portion of the second outer leg 74B to close the first and second openings 72A, 72B to form first and second closed areas 88A, 88B, (the closed areas are shown in FIG. 1). Those of ordinary skill in the art will appreciate from this disclosure that the second outer leg 74B includes a portion of a locking mechanism 90 such that when a portion of the rod 82 is housed within the locking mechanism 90, the rod 82 will, by definition, be positioned in at least a portion of the second outer leg 74B (as shown in FIG. 8).

Referring still to FIG. 5, it is preferred that the rod 82 is formed of hardened steel. It is also preferred that the rod 82 have an insertion end 92 and a second end 93. It is preferred that the insertion end 92 include a taper 91 to facilitate the slidable engagement of the rod with the first and second arcuate members 70A, 70B. The taper 91 may be formed by a beveled edge of a ratchet 96 or the like.

Referring to FIGS. 11 and 13, it is preferable that the rod 82 is sized such that the second end 93 is recessed within the first outer leg 74A when the rod 82 is fully engaged with the lock 60:1 to discourage tampering and/or prying. Referring to FIGS. 12-14, the second end 93 of the rod 82 may include a head, or cap, 86. As shown in FIG. 13, the arcuate member 74A may include a recessed shoulder 87 such that the head 86 is flush with an outer surface of the first arcuate member 74A when the rod 82 is fully engaged with the lock 60:1 to discourage hammering and/or prying of the rod 82.

Referring to FIG. 8, the locking mechanism 90 detachably secures the rod 82 to at least one of the first and second arcuate members 74A, 74B. It is preferable that the locking mechanism 90 form the second reinforcement tube 80. The locking mechanism 90 includes a lock housing 98 that is preferably part of the second outer leg 74B. A tumbler mechanism 100 is engaged with a lock member 104 via lock fingers 102. The lock member 104 is preferably biased generally downwardly by elastic member 106. To move the lock member 104 generally upwardly into a disengaged position, the tumbler mechanism 100 is manipulated to move the lock fingers 102 generally upwardly to drive the lock member 104 out of an engaged positioned (shown in FIG. 8).

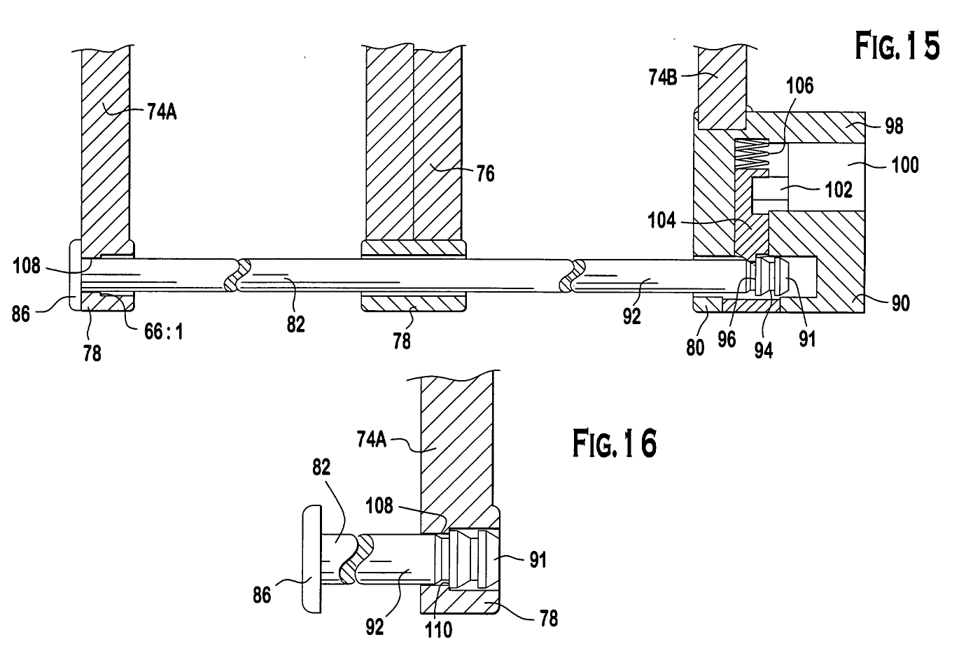

Referring to FIGS. 15 and 16, the lock 60:1 may include a rod engaging mechanism 66:1 capable of retaining a portion of the rod 82 within one of the first outer leg 74A, the central leg 76, and the second outer leg 74B when the rod 82 is disengaged from the lock mechanism 90. Referring to the left portion of FIG. 15, the first preferred rod engaging mechanism 66:1 is formed by an inwardly extending lip 108. The inwardly extending lip 108 preferably slidingly abuts the outer surface of a majority of the length of the rod 82.

The rod ratchets 96 are preferably sized such that the flat ratchet surfaces 110 can not pass through the remaining portion of the bore through the first reinforcement tube 78 due to the reduced bore clearance resulting from the inwardly extending lip 108. When the lock 60:1 is designed for with the first rod engaging mechanism 66:1, the reinforcement tube 78 formed in the first outer leg 74A is preferably larger in size then that required by the main shaft portion of the rod 82. The slightly larger bores are necessary to allow the enlarged right end of the rod 82 that is formed by the enlarged ratchets 96 to pass through the bores in the reinforcement tubes 78, 80. With the reinforcement tube 78 defining the bore, it is preferred that the pin engaging mechanism 66:1 include the inwardly directed lip 108 to obstruct the portion of the bore and to prevent the larger portion of the rod 82 from sliding past that portion of the bore.

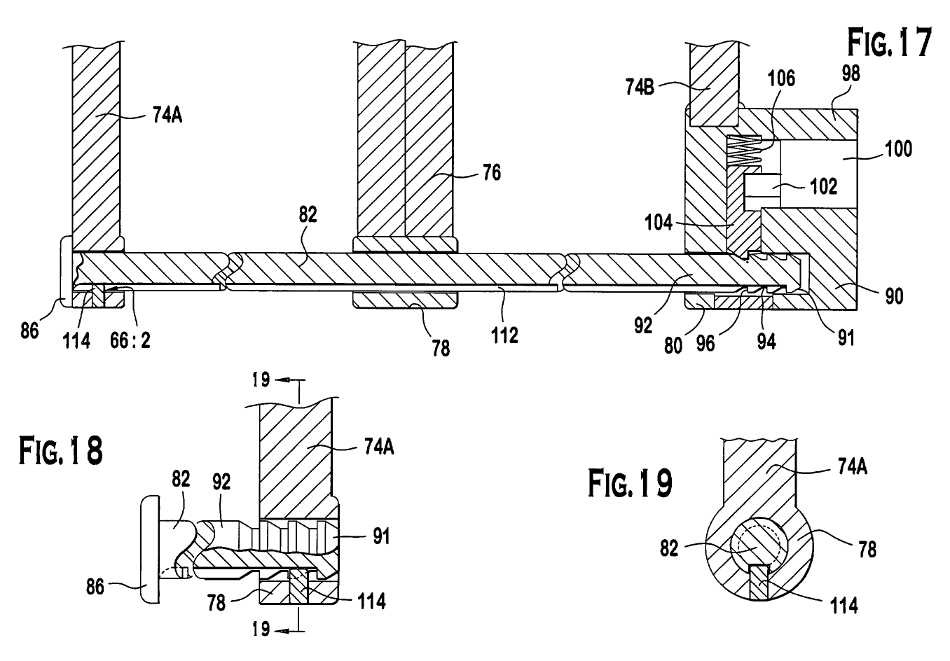

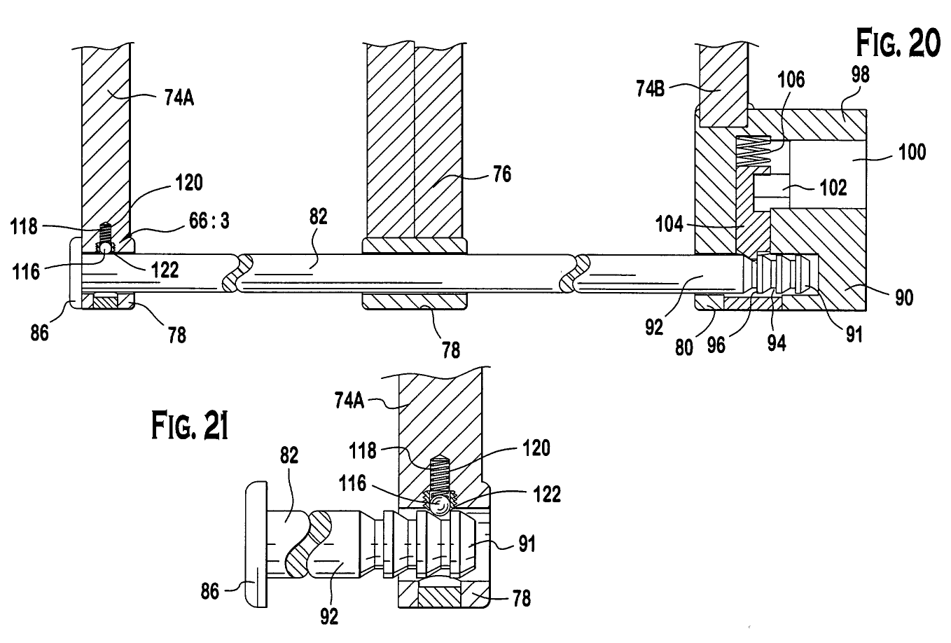

Referring to FIGS. 17-19, a second preferred rod engaging mechanism 66:2 is formed by a rod 82 having a generally longitudinal groove 112 therein. The first outer leg 74A preferably defines a bore having an inner bore surface. The rod engaging mechanism 66:2 preferably includes a rod guide 114 disposed on the inner bore surface and engaged with the longitudinal groove 112. The rod engaging mechanism 66:2 has the advantage of maintaining the rod 82 in fixed alignment during insertion and retraction of the rod 82 from the lock 60:1. When the rod 82 is disengaged from the lock mechanism 90, the pin guide 114 abuts the right most portion of the longitudinal groove 112 and prevents the rod 82 from being withdrawn. FIG. 18 best shows the potential engagement between the rod guide 114 and the end of the longitudinal groove 112 of the rod 82.

Referring to FIGS. 20 and 21, a third preferred rod engaging mechanism 66:3 is formed using a rod 82 having an at least one detent or ratchet 96 therein. The first outer leg 74A preferably defines a reinforcement tube 78 having a bore therein. The rod engaging mechanism 66:3 includes a detent engaging mechanism (which is formed by a ball bearing 116 and an elastic member 118) disposed on an inner bore surface and capable of engaging the at least one detent 96. It is preferred that the at least one detent 96 comprise at one least ratchet. The ball bearing 116 is biased downwardly by the elastic member, or spring, 118 to engage the ratchet 96 when the rod 82 is withdrawn generally leftwardly from the lock 60:1. The ball bearing 116 is housed in a ball bearing chamber 120 having an inwardly tapered lower radius 122 which prevents the ball bearing 116 from being ejected from the ball bearing chamber 120.

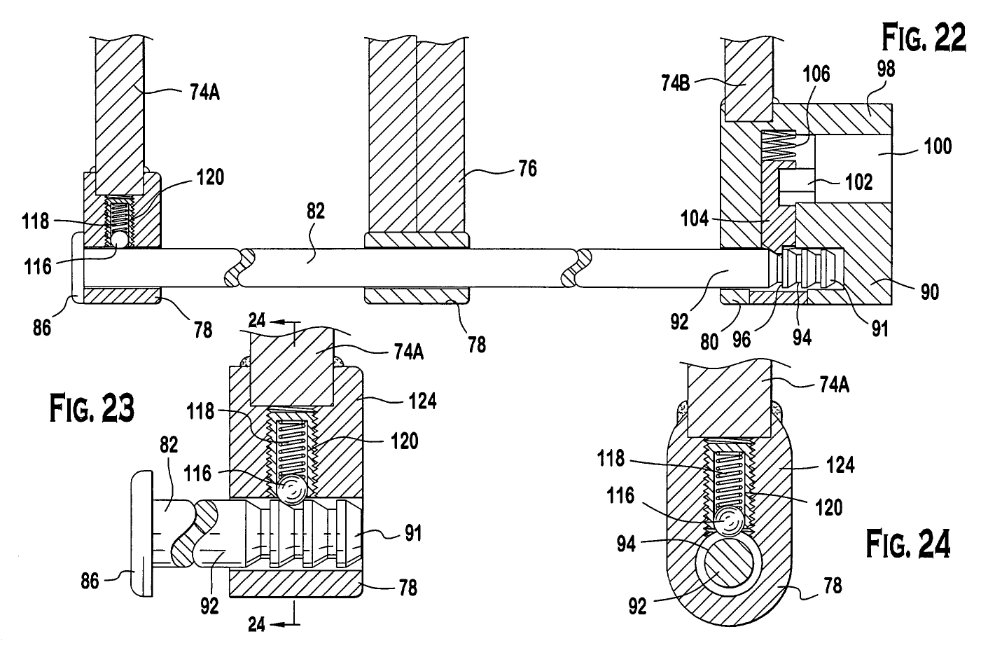

Referring to FIGS. 22-24, a fourth preferred rod engaging mechanism 66:4 is generally the same as that shown in FIGS. 20 and 21 except that the reinforcement tube 78 includes an enlarged portion 124 that allows a larger size combination ball bearing 116 and elastic member 118 to be used. This allows for stronger engagement between the ball bearing 116 and the ratchets 96 of the rod 82. Referring generally to the third and fourth preferred rod engaging mechanisms 66:3, 66:4 shown in FIGS. 20-24, these pin engaging mechanisms 66:3, 66:4 do not necessarily prevent the rod 82 from being completely withdrawn from the lock 60:1, but instead detachably retain the right end of the rod 82 until a user exerts increased force on the rod 82 to force the ratchets 96 pass the rod engaging mechanism 66:3, 66:4.

While four preferred rod engaging mechanisms 66:1-66:4 have been described above in connection with the first embodiment of the lock 60:1 according to the present invention, those of ordinary skill in the art will appreciate that any one or combination of the above described rod engaging mechanisms 66:1-66:4, or their equivalents, can be used with any of the locks 60:1-60:8 of the present invention without departing therefrom. Similarly, each of the locks 60:1-60:8 of the present invention can be used with rods 82 having second ends 93 similar to that shown in any of FIGS. 11-14 without departing from the scope of the present invention.

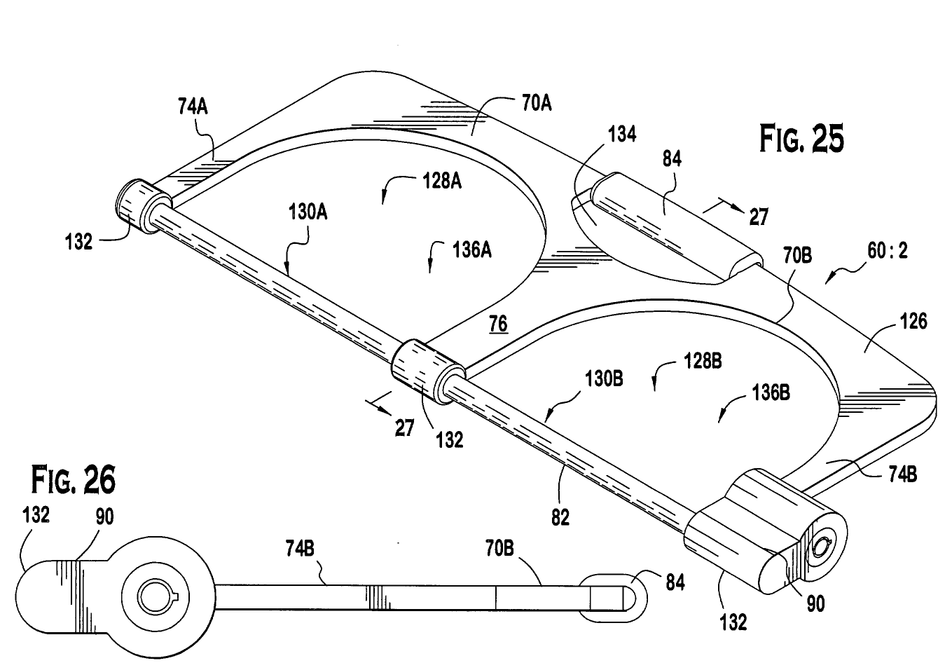

Referring to FIGS. 25-28, a second preferred embodiment of the lock 60:2 according to the present invention is shown. The lock 60:2 includes a lock body 126 that defines a first area 128A having a first opening 130A to first side 132 of the lock body 126 (the first opening 130A would be viewable in FIG. 25 if the rod 82 were removed from the lock 60:2). The lock body 126 also defines a second area 128B having a second opening 130B to first side 132 of the lock body 126. The first and second openings 130A, 130B result in the lock body having a first outer leg 74A, a central leg 76, and a second outer leg 74B. The first outer leg 74A and the central leg 76 border the first opening 130A. The second outer leg 74B and the central leg 76 border the second opening 130B. Those of ordinary skill in the art will appreciate from this disclosure that the first and second arcuate members 74A, 74B (shown in FIG. 1) can be formed in any fashion as demonstrated by the lock body 126 shown in FIG. 25.

It is preferred that the lock body 126 includes a hand grip cut-out 134. It is also preferred that the lock body 126 include a polymer grip 84 to facilitate the handling of the lock 60:2. The at least one rod 82 is detachably slidably engageable with the lock body 126 to close the first and second openings 130A, 130B and is adapted to be located in the first outer leg 74A, the central leg 76, and at least a portion of the second outer leg 74B to form first and second closed areas 136A, 136B.

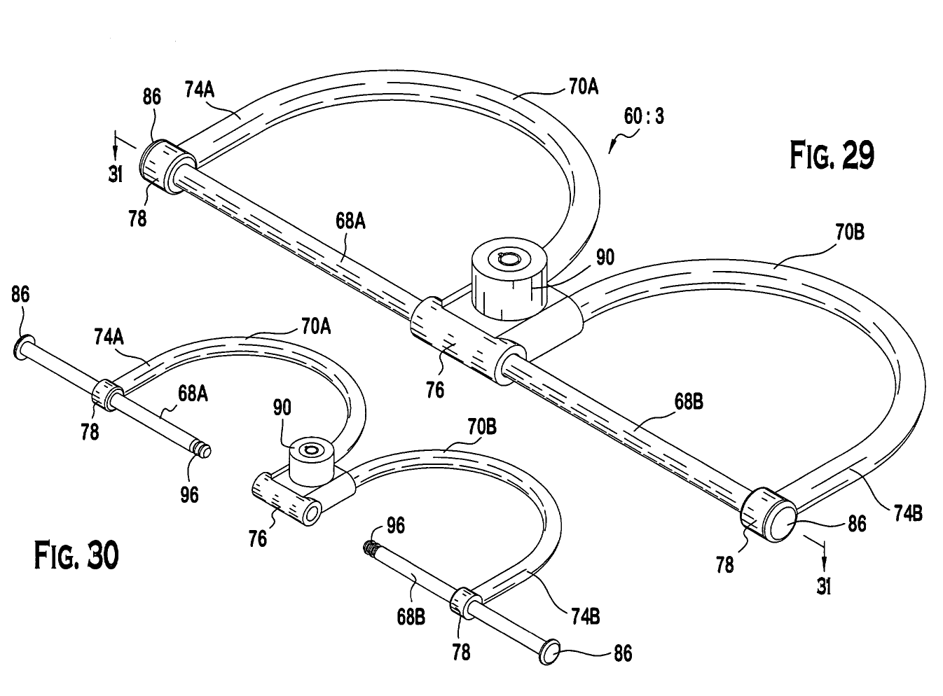

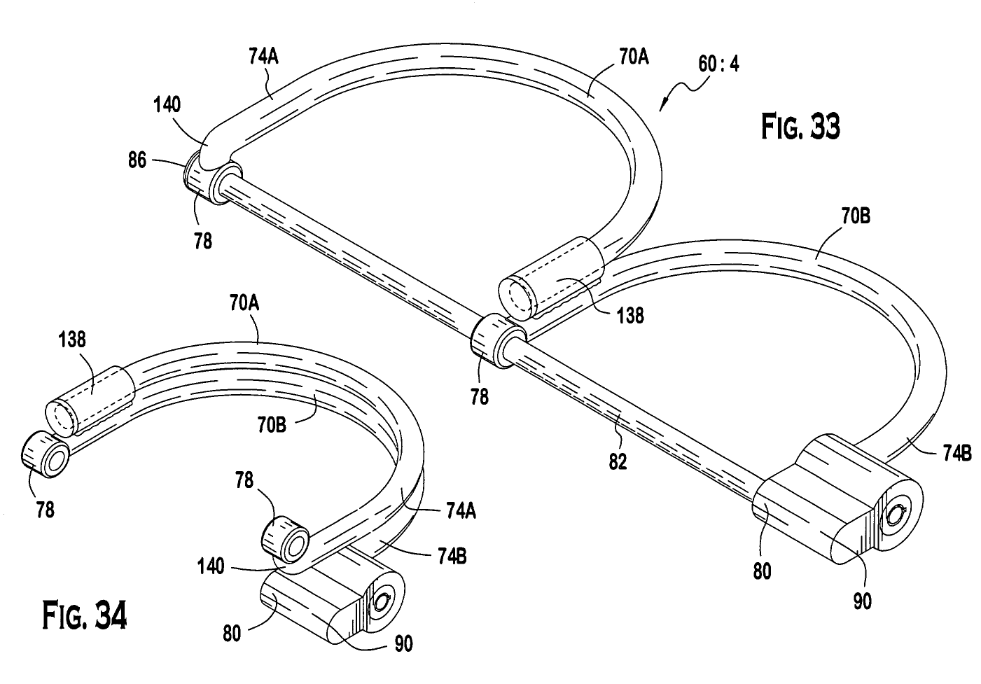

Referring to FIGS. 33-52, it is preferred that the first and second arcuate members 70A, 70B are pivotable so that the first and second arcuate members 70A, 70B can be moved between a first position, in which the first and second arcuate members are generally positioned in a single plane, and a second position, in which the first and second arcuate members generally overlap one another. Referring to FIGS. 29-31 and 48-52, it is preferred that the rod 82 include first and second pins 68A, 68B that are each secured generally centrally within the lock 60:3, 60:8 when the lock is in the first preferred positioned.

Referring to FIGS. 29-32, a third preferred lock 60:3 according to the present invention includes first and second pins 68A, 68B that are each inserted generally inwardly through opposite reinforcement tubes 78 and are generally secured by a locking mechanism 90 that is preferably located on the central leg 76. Each of the pins 68A, 68B is securable within the locking mechanism 90 via the engagement of a separate lock member 102 that is biased into engagement by an elastic member 106.

Referring to FIGS. 33-36, the first and second arcuate members 70A, 70B are preferably rotatably coupled by a sheath 138 that is positioned on the second arcuate member 70B. An end of the first arcuate member 70A is rotatably secured within the sheath 138 to allow the first arcuate member 70A to rotate relative to the second arcuate member 70B when the rod 82 is disengaged from the lock 60:4. Referring specifically to FIG. 33, the right portion of the first arcuate member 70A does not connect to a reinforcement tube 78 to allow the unobstructed rotation of the first arcuate member 70A around the right leg thereof. Additionally, the left leg of the first arcuate member 70A has a downwardly bent portion 140 that allows the corresponding reinforcement tube 78 to be properly aligned with the remaining reinforcement tubes 78, 80.

Referring to FIGS. 37-39, a fifth preferred embodiment of the lock 60:5 according to the present invention is shown. The lock 60:5 has a first arcuate member 70A that is attached to the second arcuate member 70B via a hinge connection 142. The hinge connection 142 allows for a lateral space between the inner legs of the first and second arcuate members 70A, 70B so that each of the inner legs of the first and second arcuate 70A, 70B can include a separate reinforcement tube 78. Referring to FIGS. 40-43, a sixth preferred embodiment of the lock 60:6 of the present invention is shown. The lock 60:6 includes a hinge connection 144 that allows both first and second arcuate members 70A, 70B to be located side by side.

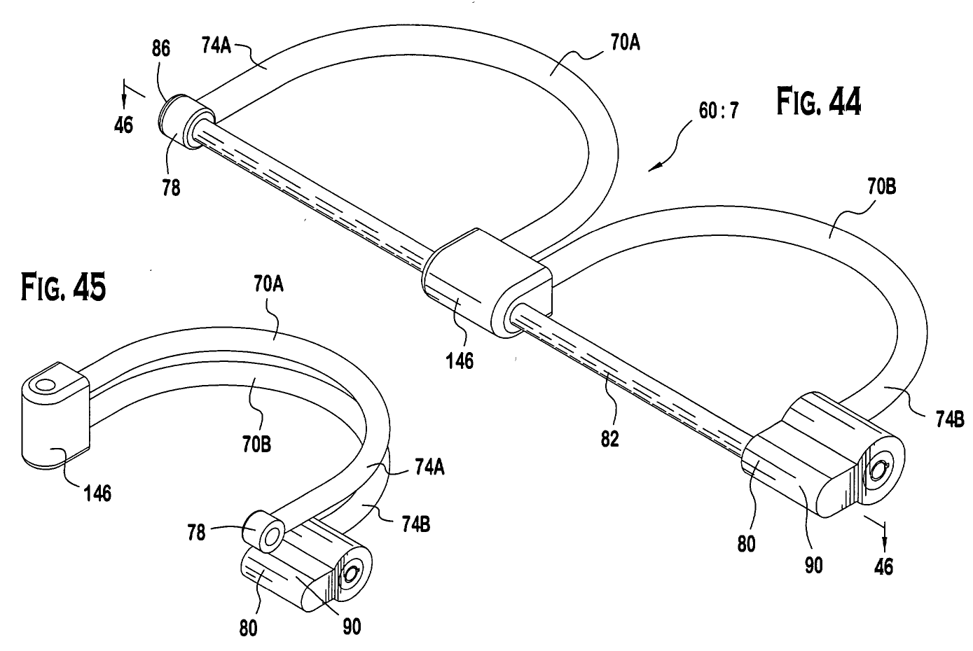

Referring to FIGS. 44-47, the inner legs of the first and second arcuate members 70A, 70B can each be rotatably lodged in a central member 146. It is preferred that each of the inner legs of the first and second arcuate members includes an enlarged portion 148 that is located within central member 146 to rotatably secure the first and second arcuate members 70A, 70B therein. Referring to FIGS. 48-52, an eighth preferred embodiment of the lock 60:8 according to present invention includes first and second arcuate members 70A, 70B that are rotatably secured by a central member 150 that detachably secures first and second pins 68A, 68B therein. This allows for the first and second arcuate members 70A, 70B to be rotatably positioned relative to each other and also allows the first and second pins 68A, 68B to be individually removed as desired.

While various features of the locks 60:1-60:8 of the present invention have been described above, those of ordinary skill in the art will appreciate from this disclosure that any of the features shown above can be combined without departing from the scope of the present invention. It is recognized by those skilled in the art that changes may be made to the above described embodiments of the invention without departing from the broad inventive concept thereof. It is understood, therefore, that this invention is not limited to the particular embodiments disclosed, but is intended to cover all modifications which are within the spirit and scope of the invention as defined by the appended claims and/or shown in the attached drawings.

I claim:

1. A lock, comprising:
a first arcuate member defining a first opening;
a second arcuate member located on the first arcuate member and defining a second opening oriented in the same direction as the first opening, the first and second arcuate members combining to form a first outer leg, a central leg, and a second outer leg, the first outer leg and the central leg bordering the first opening, the second outer leg and the central leg bordering the second opening;
at least one rod detachably slidably engageable with the first and second arcuate members and adapted to be positioned in the first outer leg, the central leg, and at least a portion of the second outer leg to close the first and second openings to form first and second closed areas; and
a locking mechanism for detachably securing the at least one rod to at least one of the first and second arcuate members.

2. The lock of claim 1, wherein the first outer leg and the central leg each include a reinforcement tube that is aligned to receive the at least one rod therethrough, the second outer leg having a second reinforcement tube for receiving the at least one rod therein.

3. The lock of claim 2, wherein the locking mechanism forms the second reinforcement tube.

4. The lock of claim 2, wherein the central leg comprises two legs that are joined together along a portion of the length of the two legs.

5. The lock of claim 1, wherein the first and second arcuate members are formed of hardened steel.

6. The lock of claim 1, wherein the first and second arcuate members have a generally circular cross section.

7. The lock of claim 1, wherein the first and second arcuate members are pivotable so that the first and second arcuate members can moved between a first position, in which the first and second arcuate members are generally positioned in a single plane, and a second position, in which the first and second arcuate members generally overlap one another.

8. The lock of claim 1, wherein the at least one rod comprises first and second pins.

9. The lock of claim 1, wherein the distance between an inner surface of the first outer leg and an inner surface of the second outer leg is between approximately twelve (12) inches and approximately seventeen (17) inches.

10. The lock of claim 1, wherein the first and second arcuate members include a polymer grip.

11. The lock of claim 1, wherein the at least one rod is formed of hardened steel.

12. The lock of claim 1, wherein the at least one rod has an insertion end and a second end.

13. The lock of claim 12, wherein the insertion end includes a taper to facilitate the slidable engagement of the at least one rod with the first and second arcuate members.

14. The lock of claim 12, wherein the at least one rod is sized such that the second end is recessed within the first outer leg when the at least one rod is fully engaged with the lock to discourage tampering and/or prying.

15. The lock of claim 12, wherein the second end of the at least one rod includes a head.

16. The lock of claim 15, wherein the first arcuate member includes a recessed shoulder such that the head is flush with an outer surface of the first arcuate member when the at least one rod is fully engaged with the lock to discourage hammering and/or prying of the at least one rod.

17. A lock, comprising:
a lock body having a first side, the lock body comprising:
the lock body defining a first area having a first opening to the first side of the lock body;
the lock body defining a second area having a second opening to the first side of the lock body;
the first and second openings resulting in the lock body having a first outer leg, a central leg, and a second outer leg, the first outer leg and the central leg bordering the first opening, the second outer leg and the central leg bordering the second opening;
at least one rod detachably slidably engageable with lock body to close the first and second openings and adapted to be located in the first outer leg, the central leg, and at least a portion of the second outer leg to form first and second closed areas; and
a locking mechanism for detachably securing the at least one rod to the lock body.

18. The lock of claim 17, wherein the first outer leg and the central leg each include a reinforcement tube that is aligned to receive the at least one rod therethrough, the second outer leg having a second reinforcement tube for receiving the at least one rod therein.

19. The lock of claim 18, wherein the locking mechanism forms the second reinforcement tube.

20. The lock of claim 17, wherein the lock body is formed of hardened steel.

21. The lock of claim 17, wherein the lock body is formed by first and second arcuate members.

22. The lock of claim 21, wherein the first and second arcuate members have a generally circular cross section.

23. The lock of claim 17, wherein the distance between an inner surface of the first outer leg and an inner surface of the second outer leg is between approximately twelve (12) inches and approximately seventeen (17) inches.

24. The lock of claim 17, wherein the lock body includes a handgrip cutout.

25. The lock of claim 17, wherein the lock body includes a polymer grip.

26. The lock of claim 17, wherein the at least one rod is formed of hardened steel.

27. The lock of claim 17, wherein the at least one rod has an insertion end and a second end.

28. The lock of claim 27, wherein the insertion end includes a taper to facilitate the slidable engagement of the at least one rod with the lock body.

29. The lock of claim 27, wherein the at least one rod is sized such that the second end is recessed within the first outer leg when the at least one rod is fully engaged with the lock body to discourage tampering and/or prying.3

30. The lock of claim 27, wherein the second end of the at least one rod includes a head.

31. The lock of claim 30, wherein the first outer leg includes a recessed shoulder such that the head is flush with an outer surface of the first outer leg when the at least one rod is fully engaged with the lock to discourage hammering and/or prying of the at least one rod.
